(19) United States
(12) Patent Application Publication
(10) Pub. No.: US 2004/0030559 A1
(43) Pub. Date: Feb. 12, 2004

(54) Color as a visual cue in speech-enabled applications

(76) Inventors: Michael J. Payne, Beaverton, OR (US); Rohan Coelho, Portland, OR (US); Maher M. Hawash, Hillsboro, OR (US)

Correspondence Address: James H. Salter, Blakely, Sokoloff, Taylor & Zafman LLP, Seventh Floor, 12400 Wilshire Boulevard, Los Angeles, CA, 90025-1030, US

(21) Appl. No.: 09/965,230

(22) Filed: Sep. 25, 2001

(51) Int. Cl. G10L 11/00

(52) U.S. Cl. 704/275

(57) ABSTRACT

Selecting a process from an information display by speaking, includes defining a bounded region on the information display, associating at least a part of the bounded region with a color, where the color is used to indicate that the process is speech-enabled and relating a command with at least one of the bounded region and the color. The command causes the process to be selected when spoken.

### BACKGROUND OF THE INVENTION

1. Field of Invention

The invention relates generally to speech enablement of software/hardware applications, and more specifically to using color as a visual cue to speech-enable a user interface to an information display.

2. Art Background

A computer software program can be configured to interact with hardware, including a microphone, making the software program or application responsive to speech. Such a configuration is referred to as being speech-enabled. Currently, these applications rely on the user remembering the commands that will trigger a response to speech. Users may refer to the application's manual or help files to learn what is and is not speech-enabled. Further reference to the manual is required to learn the particular commands that will trigger responses to speech. Problems with this methodology arise. The user's memory is taxed as the application grows in size beyond a small number of commands. An application's full potential may not be realized if the user forgets commands that are speech-enabled. The particular command phrase that must be spoken is not evident in these existing applications; reference to the application's manual or other screens is necessary to learn the required phrase.

What is needed is a way of knowing what speech commands are available to the user within the application and more particularly within the application screen without taxing the user's memory or requiring the user to refer back to the application's manual or help screens.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee. The present invention is illustrated by way of example and is not limited in the figures of the accompanying drawings, in which like references indicate similar elements.

FIG. 1 illustrates a relationship between graphical characters, graphical commands, color, and a process within a speech-enabled application.

FIG. 1a is a first screen of a speech-enabled application using the color blue to indicate which commands are speech-enabled.

FIG. 2 is a second screen of the speech-enabled application using color as a navigational aid within the speech-enabled application.

FIG. 3 illustrates the use of what is implied by a graphical character using “i.”

FIG. 4 illustrates dynamic speech hot keys.

### DETAILED DESCRIPTION

In the following detailed description of embodiments of the invention, reference is made to the accompanying drawings in which like references indicate similar elements, and in which is shown by way of illustration, specific embodiments in which the invention may be practiced. These embodiments are described in sufficient detail to enable those skilled in the art to practice the invention. The following detailed description is, therefore, not to be taken in a limiting sense, and the scope of the invention is defined only by the appended claims.

Color is used as a visual cue to inform a user as to which commands are speech-enabled within an application or an application screen. Blue is used to illustrate the invention within the context of the figures presented herein. However, another color could be used to indicate speech-enabled commands, such as the color green. The present invention is not limited by the choice of color to indicate which commands are speech-enabled.

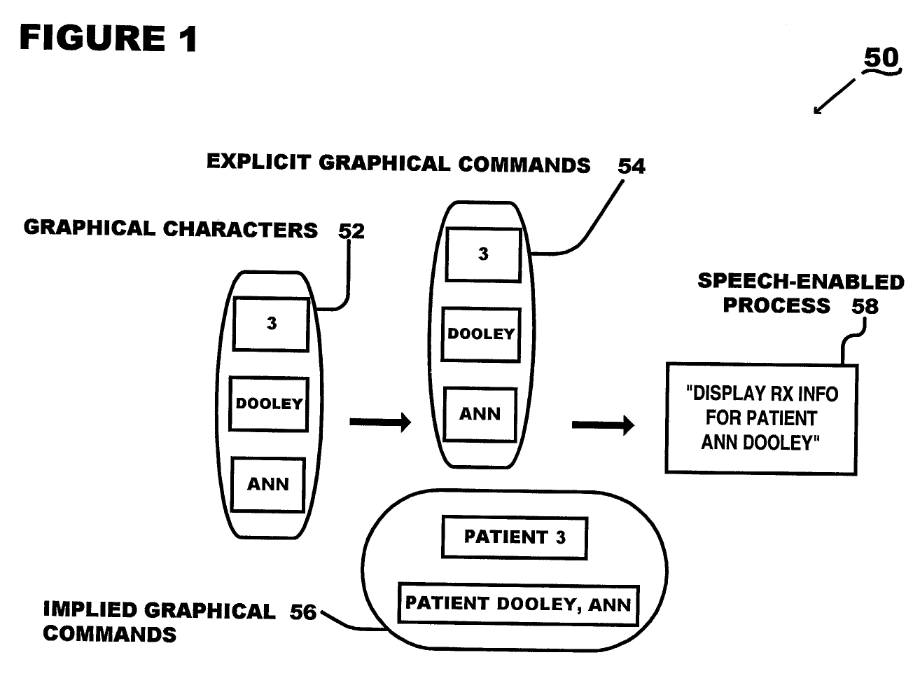

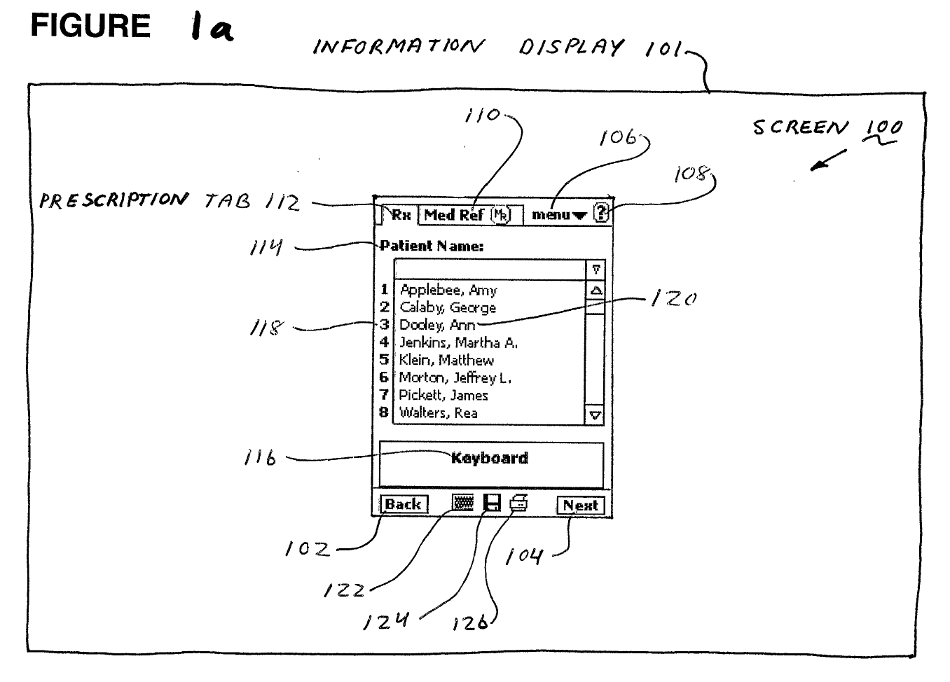

Within this description, reference will be made to “graphical character” and “graphical command.” Graphical character has broad meaning, encompassing any text, numeral, icon, or marking that is colored either in whole or in part by the color chosen to represent speech enablement. Graphical command may have broader scope than graphical character. Graphical command is the spoken form of the graphical character and encompasses what is actually expressed by the graphical character or what is implied by the graphical character. Thus, multiple speech triggers are supported to provide greater utility in the speech enablement process. FIG. 1 illustrates a relationship 50 between graphical characters, graphical commands, color, non-colored graphical characters, and a process within a speech-enabled application. With reference to FIG. 1, graphical characters 52 are seen by the user and impart knowledge to the user that the graphical characters speech-enable a range of graphical commands. The user may speak explicit graphical commands 54 or implied graphical commands 56, based on the content of the graphical characters 52 and associated non-colored characters to perform/execute/launch or trigger a speech-enabled process 58 from the speech-enabled application.

As previously mentioned, the color blue is used in FIG. 1a to indicate which commands are speech-enabled. With reference to FIG. 1a, an information display 101 is illustrated containing a screen 100 of a speech-enabled application. The graphical characters colored blue on the screen 100 are speech-enabled, whereas the graphical characters that are not colored blue are not speech-enabled. The speech-enabled application may consist of a plurality of screens. In one embodiment, speech-enabled commands may differ from a first screen to a second screen. In another embodiment, the speech-enabled commands may be the same from the first screen to the second screen. The present invention is not limited by the architecture of the speech-enabled application. FIG. 1a illustrates the first screen 100 of the speech-enabled application using the color blue to indicate which commands are speech-enabled. With reference to FIG. 1a, graphical character 102 “Back,” when spoken as a graphical command, would cause the application to execute a process of cycling back to a previous screen. Similarly graphical character 104 “Next,” when spoken as a graphical command, would cause the application to execute a process of advancing to the next screen in a sequence. In these examples, the graphical characters are in the form of the words “Back” and “Next” which are displayed in the color to blue to indicate speech-enabled graphical commands that may be executed from the first screen 100 of the speech-enabled application. As previously described, what is implied by the graphical character may also be spoken as the graphical command. “Next screen” may be a suitable graphical command to cause the application to execute the process of advancing to the next screen in the sequence. The scope of permissible phrases that result in permissible implied graphical commands is a design parameter of the application and does not limit the present invention.

In one embodiment, Icons may be used as shown with 122 (an icon of a keyboard) to represent the graphical character. Here, various graphical commands may be spoken that are implied by the graphical character 122, such as “Enter.” A process of saving information may be indicated by icon 124, which shows a disk. A process of printing information from screen 100 of the speech-enabled application is possible and indicated by the presence of printer icon 126. Printing may be initiated by speaking what is implied by the graphical character 126, such as an implied graphical command “print.”

The color of choice to indicate speech-enabled commands should be used, either in whole or in part, in association with a bounded region of the screen to indicate that the graphical character(s) corresponds to graphical command(s) that perform/execute/launch or trigger a speech-enabled process from the application. For example, icons 122, 124, and 126 are colored, at least in part, blue consistent with the description presented herein. A second region of the information display contains elements (114 and 116) that do not appear in blue, either in whole or in part, and are not directly associated with speech-enabled commands. These terms are part of the application but are not explicitly connected with speech-enabled commands and processes by themselves. For example, speaking “Keyboard” will not perform/execute/launch or trigger a speech-enabled process from the application. However, these terms may be used in association with a graphical character(s) to help convey to the user what is implied by the graphical character(s), resulting in a range of permissible implied graphical commands. For example, “patient name” 114 may be used in association with “Ann” 120 to imply the graphical command “patient Ann,” or “patient Ann Dooley” which then performs/executes/launches or triggers a speech-enabled process from the application.

Logical association of graphical characters may be used to associate a plurality of characters on screen 100 with each other to perform/execute/launch or trigger a common speech-enabled process from the application. For example, 118 “3” and 120 “Ann Dooley” may be associated together such that by speaking “3” or “Ann Dooley” the same process is performed/executed/launched or triggered from the application. Additionally, logical association of non-blue elements may be combined with blue elements to imply various graphical commands that will launch the process. For example, 114 may be combined with 118 to imply graphical command “Patient 3.” An alternative combination could be 114 and 120 implying graphical command “Patient Ann Dooley.” Many other implied graphical commands are possible within the teaching of the present invention using color as described herein.

Graphical characters such as the question mark “?” at 108 may imply the graphical command “help.” Multiple graphical commands may be used to indicate the same process as shown at 110; here “Med Ref” and “MR” are used to denote “medical reference.” A menu is indicated at 106 with the graphical command “menu.”

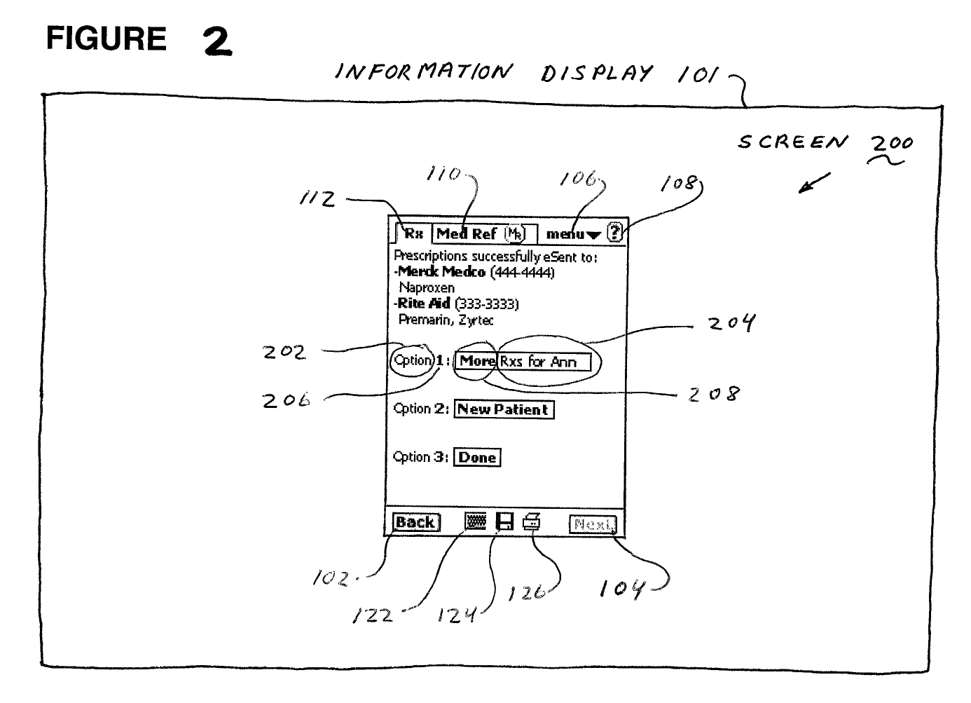

Another screen of the speech-enabled application may be displayed by speaking the graphical command at 104 “next” resulting in screen 200 being displayed on the information display 101, as shown in FIG. 2. FIG. 2 is a second screen of a speech-enabled application illustrating some speech-enabled graphical characters that are different from the first screen and some that are the same. Color may also be used as a navigational aid within the application as shown in FIG. 2. The color of the graphical character “Next” at 204 is no longer blue in screen 200, indicating that this formerly available graphical character (in screen 100 FIG. 1a) is no longer available from the present screen to be used as the graphical command to initiate the process that cycles forward to a next screen. This example illustrates using color as the navigational aid to indicate the end of a succession of screens that may be arranged in a path or tree structure. The graphical character “Back” at 102 is available as a navigational choice; in this way color is being used as the navigational aid to decide which way to proceed within the speech-enabled application.

In one embodiment, new graphical commands are evident in screen 200. Here various associations of graphical characters, such as “1” at 206 and “More” at 208 may be used to perform/execute/launch or trigger a speech-enabled process from the application. As described in conjunction with FIG. 1a, non-blue elements may be associated with the graphical characters to form associations that imply graphical commands to perform/execute/launch or trigger a speech-enabled process from the application, such as using 202 and 206 to speak the graphical command “Option 1.” In addition, 204 may be combined with 208 to imply the graphical command “More Rxs for Ann” or “Option 1 for Ann.

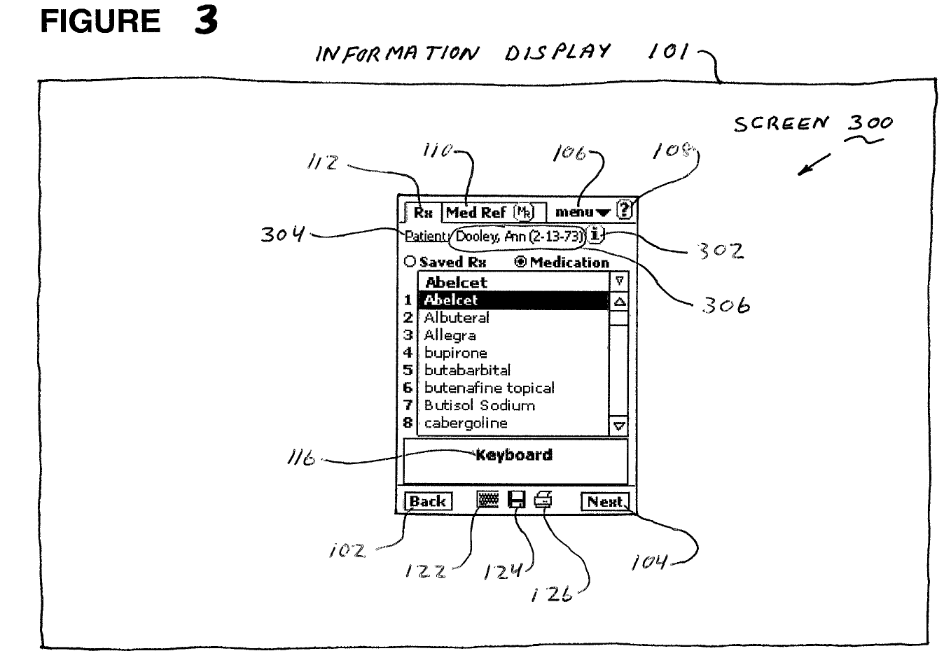

“In another embodiment, FIG. 3 illustrates the use of what is implied by a graphical character using “i.” Here, the graphical character “i” at 302, when spoken as a graphical command would perform/execute/launch or trigger a speech-enabled process from the application. Alternatively, information is implied from the graphical character at 302. Therefore speaking the implied graphical command “information” or “info” would perform/execute/launch or trigger the same speech-enabled process from the application. Various combinations of a graphical character “patient” at 304 and non-blue elements at 306, “Dooley, Ann (Feb. 13, 73)” may be logically associated to imply graphical commands to perform/execute/launch or trigger the same speech-enabled process from the application.

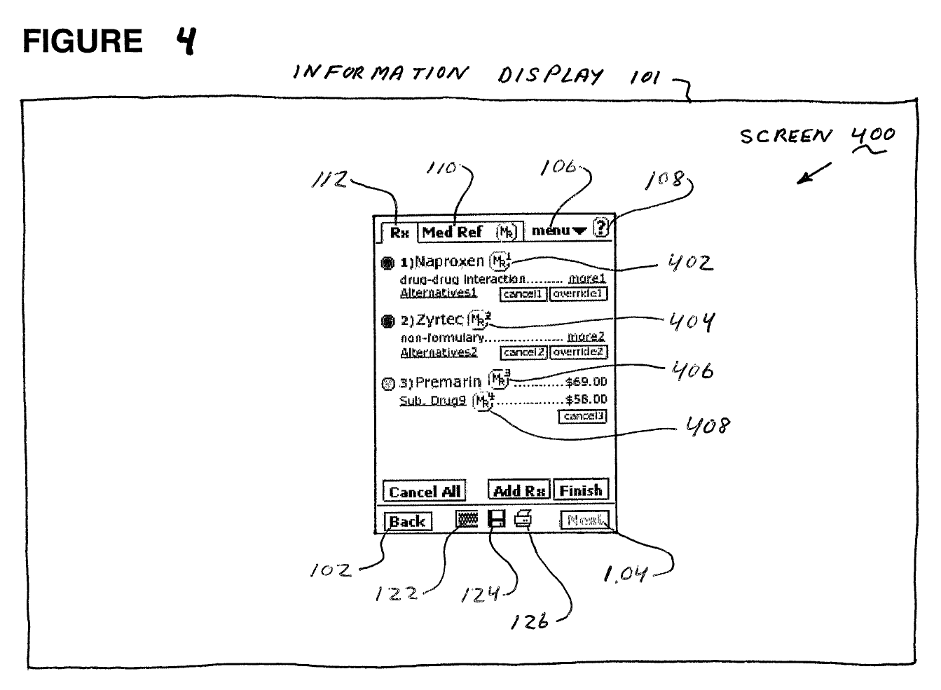

Another term for graphical character that will be used in this description is “speech hotkey.” In some speech-enabled applications it may be convenient to express a region on the information display in the form or shape of a “key” or a “button” according to terms commonly used in the art. Therefore, speech hotkey may be used interchangeably with graphical character, no limitation is implied by the use of one term or the other term. Speech hotkeys may be configured to be dynamic. FIG. 4 illustrates the use of dynamic speech hot keys. With reference to FIG. 4, 402, 404, 406 and 408 represent speech hotkeys. The speech hotkeys change based on how much of a specific content a screen contains (e.g., how many different drug names are on the screen) and where that content is located on the screen (e.g., depending on where “Naproxen” is on the screen in relationship to the other drug names). For example, four drugs are shown in FIG. 4 on screen 400 and are referenced with hotkeys, 402, 404, 406, and 408. If three drugs had been returned instead, only 402, 404, and 406 would be listed. Thus, the number of hotkeys is dynamically adjusted based on the results of a particular process executed within the application.

In one embodiment, anytime a drug name appears on the page, a “MR” icon is placed next to it. Activating this icon, by speaking the graphical command associated with the icon will take the user to medical reference information for the associated drug. In a typical, non-speech-enabled application, the “MR” icons would all be the same because they perform the same action for their associated drugs and there is no need to uniquely distinguish the meaning of the icons by where they are located on the page (i.e., which drug they are next to). The user would simply click on the desired icon with a stylus. In the context of the speech-enabled application explained herein, the user would speak the graphical command “MR” plus the number, required to make the combination unique, in order to access medical reference information for the associated drug. For example, if the user desired to go to medical reference information for Zyrtec, the user would say, “MR two.” If the user desired to go to medical reference information for Premarin, the user would say, MR Three.” And as described above, the user can also voice what is implied by the speech hotkey, which is “Med Ref 2” or “Medical Reference 2.” Thus, speech hotkeys (graphical characters) may be used dynamically according to the results of the speech-enabled process within the speech-enabled application.

It will be appreciated that the methods described in conjunction with the figures may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions, which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals. Furthermore, it is common in the art to speak of software, in one form or another (e.g., program, procedure, process, application, module, logic. . . ), as taking an action or causing a result. Such expressions are merely a shorthand way of saying that execution of the software by a computer causes the processor of the computer to perform an action or a produce a result.

Thus, a novel method and apparatus to select a process by speaking a command both explicitly and impliedly by a user in a speech-enabled application is disclosed. Although the invention is described herein with reference to specific preferred embodiments, many modifications therein will readily occur to those of ordinary skill in the art. Accordingly, all such variations and modifications are included within the intended scope of the invention as defined by the following claims.

What is claimed is:

1. A method to select a process from an information display by speaking, comprising:
defining a bounded region on the information display;
associating at least a part of said bounded region with a color, wherein
said color is used to indicate that the process is speech-enabled; and
relating a command with at least one of said bounded region, and said color, wherein said command causes the process to be selected when spoken.

2. Said method of claim 1, wherein the information display is at least one of a two-dimensional display, a three-dimensional display, and a holographic display.

3. Said method of claim 1, wherein said bounded region is in a shape of at least one of a character, a square, a curvilinear object, and a button.

4. Said method of claim 1, further comprising navigating a speech-enabled application by using said color to indicate when the process can be selected.

5. A method to select a process from an information display by speaking, comprising:
defining a bounded region on the information display;
associating at least a part of said bounded region with a color, wherein said color is used to indicate that the process is speech-enabled;
associating a second region of the information display with said bounded region; and
relating a graphical command with at least one of said bounded region, said second region, and said color, wherein said graphical command causes the process to be selected when spoken.

6. Said method of claim 5, wherein the information display is at least one of a two-dimensional display, a three-dimensional display, and a holographic display.

7. Said method of claim 5, wherein said bounded region is in a shape of at least one of a character, a square, a curvilinear object, and a button.

8. A method to select a process from an information display by speaking, comprising:
defining a bounded region on the information display;
associating at least a part of said bounded region with a color, wherein
said color is used to indicate that the process is speech-enabled;
associating a second region of the information display with said bounded region; and
relating what is implied by a graphical command with at least one of said bounded region, said second region, and said color, wherein what is implied by said graphical command causes the process to be selected when spoken.

9. Said method of claim 8, wherein the information display is at least one of a two-dimensional display, a three dimensional display, and a holographic display.

10. Said method of claim 8, wherein said bounded region is in a shape of at least one of a character, a square, a curvilinear object, and a button.

11. A computer readable medium containing executable computer program instructions, which when executed by a data processing system, cause the data processing system to perform a method to select a process from an information display by speaking, comprising:
defining a bounded region on the information display;
associating at least a part of said bounded region with a color, wherein
said color is used to indicate that the process is speech-enabled; and
relating a command with at least one of said bounded region, and said color, wherein said command causes the process to be selected when spoken.

12. Said computer readable medium, as set forth in claim 11, wherein the information display is at least one of a two-dimensional display, a three-dimensional display, and a holographic display.

13. Said computer readable medium, as set forth in claim 11, wherein said bounded region is in a shape of at least one of a character, a square, a curvilinear object, and a button.

14. A computer readable medium containing executable computer program instructions, which when executed by a data processing system, cause the data processing system to perform a method to select a process from an information display by speaking, comprising:
defining a bounded region on the information display;
associating at least a part of said bounded region with a color, wherein
said color is used to indicate that the process is speech-enabled;
associating a second region of the information display with said bounded region; and
relating a graphical command with at least one of said bounded region, said second region, and said color, wherein said graphical command causes the process to be selected when spoken.

15. Said computer readable medium, as set forth in claim 14, wherein the information display is at least one of a two-dimensional display, a three-dimensional display, and a holographic display.

16. Said computer readable medium, as set forth in claim 14, wherein said bounded region is in a shape of at least one of a character, a square, a curvilinear object, and a button.

17. Said computer readable medium, as set forth in claim 14, wherein said method further comprises navigating a speech-enabled application by using said color to indicate when the process can be selected.

18. A computer readable medium containing executable computer program instructions, which when executed by a data processing system, cause the data processing system to perform a method to select a process from an information display by speaking, comprising:
defining a bounded region on the information display;
associating at least a part of said bounded region with a color, wherein
said color is used to indicate that the process is speech-enabled;
associating a second region of the information display with said bounded region; and
relating what is implied by a graphical command with at least one of said bounded region, said second region, and said color, wherein what is implied by said graphical command causes the process to be selected when spoken.

19. Said computer readable medium, as set forth in claim 18, wherein the information display is at least one of a two-dimensional display, a three-dimensional display, and a holographic display.

20. Said computer readable medium, as set forth in claim 18, wherein said bounded region is in a shape of at least one of a character, a square, a curvilinear object, and a button.

21. An apparatus to select a process by speaking, comprising:
an information display having a bounded region, wherein at least part of said bounded region is associated with a color that is used to indicate that the process is speech-enabled, such that a command associated with at least one of said bounded region and said color, causes the process to be selected by speaking the command.

22. Said apparatus of claim 21, wherein said information display is at least one of a two-dimensional display, a three-dimensional display, and a holographic display.

23. Said apparatus of claim 21, wherein said bounded region is in a shape of at least one of a character, a square, a curvilinear object, and a button.

24. An apparatus to select a process by speaking, comprising:
an information display having a bounded region, wherein at least part of said bounded region is associated with a color that is used to indicate that the process is speech-enabled; and
a second region of said information display, wherein said bounded region is associated with said second region, such that a graphical command associated with at least one of said bounded region, said second region, and said color, causes the process to be selected by speaking said graphical command.

25. Said apparatus of claim 24, wherein said information display is at least one of a two-dimensional display, a three-dimensional display, and a holographic display.

26. Said apparatus of claim 24, wherein said bounded region is in a shape of at least one of a character, a square, a curvilinear object, and a button.

27. An apparatus to select a process by speaking, comprising:
an information display having a bounded region, wherein at least part of said bounded region is associated with a color that is used to indicate that the process is speech-enabled; and
a second region of said information display, wherein said bounded region is associated with said second region, such that what is implied by a graphical command associated with at least one of said bounded region, said second region, and said color, causes the process to be selected by speaking what is implied by said graphical command.

28. Said apparatus of claim 27, wherein said information display is at least one of a two-dimensional display, a three-dimensional display, and a holographic display.

29. Said apparatus of claim 27, wherein said bounded region is in a shape of at least one of a character, a square, a curvilinear object, and a button.

30. Said apparatus of claim 27, wherein a speech-enabled application is navigated by using said color to indicate when the process can be selected by speaking.
